(19) United States
(12) Patent Application Publication
(10) Pub. No.: US 2016/0180044 A1
(43) Pub. Date: Jun. 23, 2016

(54) MOBILE HEALTHCARE HUB

(71) Applicant: KONINKLIJKE PHILIPS N.V., EINDHOVEN (NL)

(72) Inventors: NORMAN MAURICE DELISLE, MANCHESTER, MA (US); PATRICK GUINEY, CONCORD, MA (US); JEFF HEYMAN, SOMMERVILLE, MA (US)

(21) Appl. No.: 14/972,287

(22) Filed: Dec. 17, 2015

Related U.S. Application Data
(60) Provisional application No. 62/093,108, filed on Dec. 17, 2014.

(51) Int. Cl. G06F 19/00

(52) U.S. Cl. CPC G06F 19/3406; G06Q 50/24

(57) ABSTRACT

A mobile healthcare hub includes a processor, memory coupled to the processor and a display coupled to the processor. A communications module includes a mobile communication device configured to communicate with one or more monitoring devices. The one or more monitoring devices are configured to store measurement data and/or historic data for a particular patient. The mobile communications device is connected to the one or more monitoring devices upon entering a communication envelope. An information monitoring module is configured to receive, consolidate and process the measurement data and/or historic data for the particular patient from the one or more monitoring devices based upon relevance and context. A display formatting module is configured to receive the measurement data and/or historic data for the particular patient and format the measurement data and/or historic data for display on the display.

### BACKGROUND

1. Technical Field

This disclosure relates to communications between medical instruments and more particularly to a mobile hub providing interconnectivity between multiple devices.

2. Description of the Related Art

Remote data connectivity integration between multiple different devices on the same platform is not readily available especially for medical environments. Collections of medical devices, tablets, laptop computers, patient data information systems, etc. are often separately deployed and connected using public networks or hardwired on local wireless networks.

In common pre-hospital emergency medical practice, paramedics carry a small number of medical devices to respond to emergency situations. Typically, they use a monitor/defibrillator, such as a Philips® HeartStart MRx™, as the primary medical device. The monitor/defibrillator provides vital patient measurements including ECG, SpO2, NBP and EtCO2. The monitor/defibrillator also provides electrical therapies including defibrillator shock, synchronized cardioversion and transcutaneous pacing. Typically, an ambulance is also equipped with oxygen and possibly a ventilator. Some emergency medical services (EMS) are equipped with laptop or tablet computers with software for displaying ambulance dispatch data and for entering patient care records. More advanced EMS agencies can also have wireless data communications with hospitals for forwarding medical data prior to arrival.

Monitor/defibrillator devices, such as Philips® HeartStart MRx™, have capabilities to wirelessly transmit data to patient information systems in a hospital. For example, a 12 ECG can be acquired by a device at a patient site in the field and transmitted via cellular communication technologies to an ECG analysis workstation computer at the hospital so that a cardiologist can provide a remote diagnosis.

On the data management side, there are a variety of EMS oriented patient management systems, generally referred to as electronic patient care record (ePCR) systems. Some of these systems have capabilities for importing patient incident data from monitor/defibrillators, integrating this data with the overall patient event record and transmitting this data to remote data repositories.

Other systems are capable of adding interface and storage capabilities to an existing monitoring device for aggregating data related to an EMS event from the monitor and an asset management database and transmitting that data to a data storage system. The monitoring device can be a defibrillator, and the system can include a defibrillator and a tablet.

With standard EMS practice, when dispatched on an emergency call, the paramedics treat and stabilize the patient at the site and then transport the patient to the hospital. With the growing trend toward community paramedicine, EMS agencies find that many patients could be better served by a more flexible array of care options. For example, paramedics make regularly scheduled home visits to perform medical assessments and to ensure that patients are taking their prescribed medications and follow up with their primary care providers. Dispatchers can be replaced by triage nurses to help callers find appropriate treatment for their medical issues.

Another trend is toward the use of medical devices within the home for continued monitoring of chronic patient conditions such as congestive heart failure. Philips® TeleStation™ provides wireless sensors for ECG, SPO2, NBP and weight and forwards the data to a central monitoring location for monitoring and trending. If the patient condition degrades, appropriate medical action can be taken before the situation becomes more serious.

### SUMMARY

In accordance with principles of the present invention, a mobile healthcare hub includes a processor, memory coupled to the processor and a display coupled to the processor. A communications module includes a mobile communication device configured to communicate with one or more monitoring devices. The one or more monitoring devices are configured to store measurement data and/or historic data for a particular patient. The mobile communications device is connected to the one or more monitoring devices upon entering a communication envelope. An information monitoring module is configured to receive, consolidate and process the measurement data and/or historic data for the particular patient from the one or more monitoring devices based upon relevance and context. A display formatting module is configured to receive the measurement data and/or historic data for the particular patient and format the measurement data and/or historic data for display on the display.

Another mobile healthcare hub in accordance with principles of the present invention includes a portable computer device having an external hardware module, the external hardware module, includes a mobile communication device configured to communicate with one or more monitoring devices. The one or more monitoring devices are configured to store measurement data and/or historic data for a particular patient. The mobile communications device is connected to the one or more monitoring devices upon entering a communication envelope. An information monitoring module is configured to receive, consolidate and process the measurement data and/or historic data for the particular patient from the one or more monitoring devices based upon relevance and context. A display formatting module is configured to receive the measurement data and/or historic data for the particular patient and format the measurement data and/or historic data for display on a display. A security module is configured to authorize access to the one or more monitoring devices by the hub when the hub enters the communications envelope of the one or more monitoring devices.

A method for remotely accessing patient data includes providing a mobile healthcare hub having at least one processor, memory coupled to the at least one processor, a display coupled to the processor, and a communications module including a mobile communication device configured to communicate with one or more monitoring devices, the one or more monitoring devices being configured to store measurement data and/or historic data for a particular patient; an information monitoring module configured to receive, consolidate and process the measurement data or historic data for the particular patient from the monitoring devices based upon relevance and context and a display formatting module configured to receive the measurement data or historic data for the particular patient and format the measurement data or historic data; entering a communications envelope of the one or more monitoring devices by the hub; establishing communications between the one or more monitoring devices and the hub; collecting patient data including the measurement data and/or historic data for the particular patient from the one or more monitoring devices; and formatting and consolidating the patient data for display on a display of the hub.

These and other objects, features and advantages of the present disclosure will become apparent from the following detailed description of illustrative embodiments thereof, which is to be read in connection with the accompanying drawings.

### BRIEF DESCRIPTION OF DRAWINGS

This disclosure will present in detail the following description of preferred embodiments with reference to the following figures wherein:

FIG. 1 is a block/flow diagram showing a mobile healthcare hub employed for patient monitoring and information gathering in accordance with one embodiment;

FIG. 2 is a block/flow diagram showing a mobile healthcare hub system with monitoring devices for patient monitoring and information gathering in accordance with one embodiment; and

FIG. 3 is a flow diagram showing a method for remotely accessing patient data in accordance with illustrative embodiments.

### DETAILED DESCRIPTION OF EMBODIMENTS

In accordance with the present principles, a mobile, portable device is provided that exchanges data with multiple medical devices and electronic patient data record systems. In one embodiment, a computer (e.g., a tablet or the like) can be configured and possibly augmented with custom electronics, and with wireless and/or cabled connections to the multiple medical devices and information systems for exchanging data with these devices and systems. The computer can include software for displaying, processing, storing and transmitting the data and controlling the medical devices. Processing can include detecting alarm conditions, running sophisticated diagnostic algorithms, identifying appropriate communication protocols, etc.

The present principles simplify clinical workflow by automating the aggregation of patient data from multiple on-scene medical devices and multiple remote data management systems into a single electronic medical record. The present principles can improve patient outcomes by enabling more informed decisions for a mobile caregiver since the caregiver can access patient medical history data and information about current vitals and therapies and receive remote support from specialists who have access to all the data available at the patient location.

The present principles extend monitor/defibrillator data transmission capabilities by aggregating patient data from a variety of medical devices and patient information systems. A monitoring hub can be integrated with many types of medical devices and patient information systems, which can provide a wide variety of modular healthcare capabilities. The present embodiments integrate data from and control of a variety of on-site medical devices, and are not restricted to a monitor/defibrillator. The present embodiments further permit access to historical patient information, and are not restricted to data for a current EMS incident.

With this expanding role of medical care outside the hospital, there is increasing opportunity to provide mobile healthcare providers with comprehensive data regarding the patient's condition and medical history. Instead of arriving at an accident scene with only a brief description of the patient's medical issue relayed by a dispatcher, paramedics benefit by being able to access the patient's medical history and recent care and monitoring records while en route to an emergency scene. A triage nurse can also make better decisions with access to more than the limited information that can be obtained during a 911 call.

In accordance with one embodiment, a mobile healthcare hub is provided that includes a real time display and control of a suite of on-scene medical devices, an aggregation of inbound patient event data to include vital data from all on-scene medical devices, mobile access to patient history records, a closed loop integration of devices for improved efficacy, etc.

It should be understood that the present invention will be described in terms of medical instruments; however, the teachings of the present invention are much broader and are applicable to any suite or different instruments/devices which can be controlled by and report data to a hub. In some embodiments, the present principles are employed in tracking or analyzing complex biological or mechanical systems. In particular, the present principles are applicable to tracking statuses of patients, biological systems, computer systems or devices, etc. The elements depicted in the FIGS. can be implemented in various combinations of hardware and software and provide functions which can be combined in a single element or multiple elements.

The functions of the various elements shown in the FIGS. can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), non-volatile storage, etc.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure). Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams and the like represent various processes which can be substantially represented in computer readable storage media and so executed by a computer or processor, whether or not such computer or processor is explicitly shown.

Furthermore, embodiments of the present invention can take the form of a computer program product accessible from a computer-usable or computer-readable storage medium providing program code for use by or in connection with a computer or any instruction execution system. For the purposes of this description, a computer-usable or computer readable storage medium can be any apparatus that can include, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W), Blu-Ray™ and DVD.

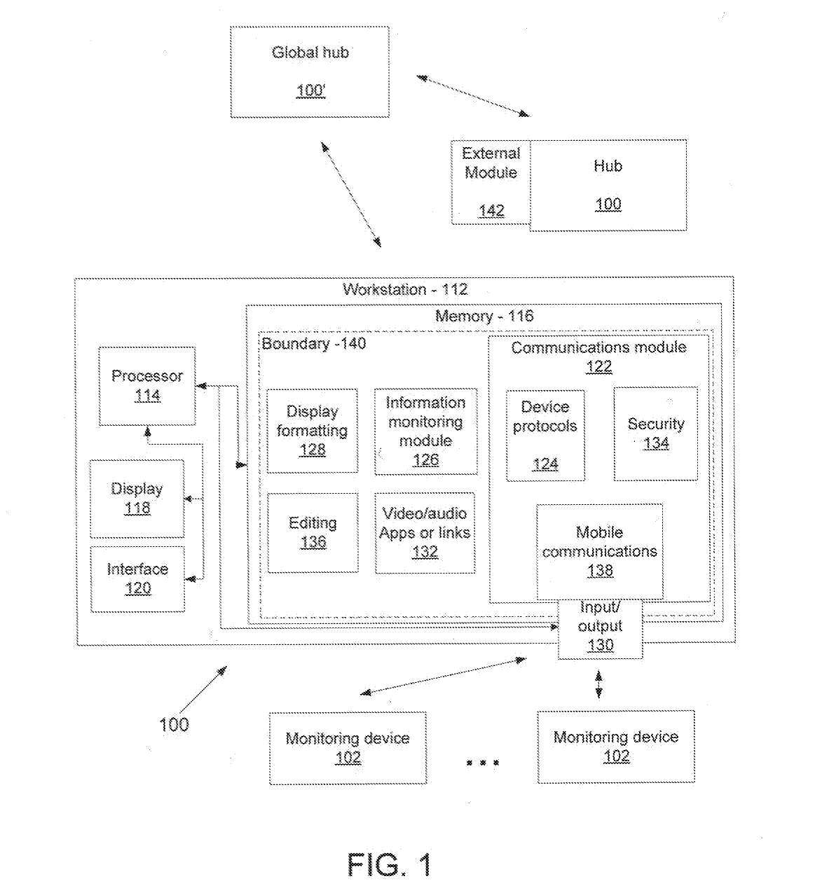

Referring now to the drawings in which like numerals represent the same or similar elements and initially to FIG. 1, a mobile medical hub system 100 is illustratively shown in accordance with one embodiment. System 100 can include a workstation, console or mobile computing device 112 for managing and/or controlling multiple medical or other input devices or instruments. Workstation 112 preferably includes a portable computer or portable computer-like device. Some examples include tablets, laptops, smart phones, etc. The workstation 112 can be specially configured in aspects of both hardware and software. In one embodiment, the workstation 112 includes one or more processors 114 and memory 116 for storing programs and applications. Memory 116 can store a plurality of different modules configured to permit access to and communications with a plurality of different devices or instruments. A communications module 122 includes programs, protocols and applications for establishing and carrying out communications with known or unknown devices or instruments 102. Emergency personnel entering a scene may have knowledge of one or more instruments 102 at the scene, but may not know about all instruments from which data can be collected. The communications module 122 will look for relevant data sources and establish communications with such devices. The communications module 122 includes a mobile communication device 138, which is configured to communicate with one or more monitoring devices 102. The one or more monitoring devices 102 are configured to store measurement data and/or historic data for a particular patient. The mobile communications device 138 is connected to the one or more monitoring devices 102 upon entering a communication envelope. The communications envelope can include a Bluetooth® or WiFi region, a cellular network or cell site, a local network or a wired connection to the hub or workstation 112.

The mobile communications device 138 can include an electronic or electrical interface configured for wired or wireless communication with one or more of the monitoring devices 102. In one embodiment, the mobile communications device 138 can include one or more ports 130, which can be employed for connecting to, e.g., an ultrasound probe for gathering image data from a patient, a bar code scanner for scanning bar codes, etc.

Many devices can easily be linked up with the workstation 112 using common wireless protocols, such as Bluetooth®, WiFi through existing networks, cellular technology, or protocols through direct wired connections. Communications module 122 can include other device protocols 124 that are suitable for use with medical devices or other most likely available for popular devices or instruments. The device protocols listing in module 124 can be customized for particular applications or can include protocols for different collections or versions for devices or instruments.

The workstation 112 includes an information monitoring module 126 that interprets data from multiple devices (monitoring devices) and displays the data efficiently on a display device 118 using a display formatting module 128. For example, current pacer data can be displayed with recorded pacer data from a patient's history profile, or a patient's present temperature from a temperature sensor can be displayed with blood pressure data on a same screen, etc.

The information monitoring module 126 is configured to receive, consolidate and process the measurement data and/or historic data for the particular patient from the one or more monitoring devices based upon relevance and context. Relevance can refer to a latest measurement, a measurement made before or after an event, etc. Context can include the type of treatment, sickness, ailment, etc. For example, an EMS worker can be responding to a cardiac arrest event, in such a case, the patient's prior ankle sprain is of little relevance and outside of the current context of the emergency call. Relevance and context scoring can be performed by the information monitoring module 126. This scoring can be employed to determine the display formatting as higher ranked relevant and/or contextual medical data and history will have a higher likelihood of being prominently display in a display pane on a display 118. Scoring can be derived manually or automatically by setting scoring parameters and values in advance. Different scoring methods may be known to those skilled in the art.

The display formatting module 128 is configured to receive the measurement data and/or historic data for the particular patient and format the measurement data and/or historic data for display on display 118. The relevance and context scores from the information monitoring module 126 can be employed for rating the relevance and context of the data from multiple monitoring devices. The display formatting module 128 prioritizes the data for display and configures the display panes on the display accordingly. This can be performed under the guidance of the information monitoring module 126.

Workstation 112 includes the display 118 for viewing subject (patient) data (past and present), current or past measurements, etc. Display 118 can also permit a user to interact with the workstation 112 and its components and functions, or any other element within the system 100. Display 118 can include touch screen functionality and in that way can act as a user interface 120. System interaction can be further facilitated by the interface 120, which can include a keyboard, mouse, a joystick, a haptic device, or any other peripheral or control to permit user feedback from and interaction with the workstation 112.

Data can be collected from or output to one or more external devices (monitoring devices) through an input/output port 130 as part of the mobile communications device 138. The port 130 can include a wireless antenna or antennae, a cable connection port, such as a USB or other standard port, a specialized port, a plurality of different ports, an ultrasonic probe connection port, etc. Port 130 can include a barcode scanner for reading patient identification and scanning medications. Video and audio applications or links 132 can be provided for consulting with remote medical specialists (i.e., telemedicine). The memory 116 stores links or apps (132) for connecting with healthcare specialists through the hub 100. This is preferably a direct link for video or audio conferencing with the specialists using the hub 100.

In one embodiment, the hub 100 can include a tablet computer (or other mobile computing device) configured with specific ruggedization features or even a standard tablet, smart phone, laptop or the like, configured in accordance with the present principles. The tablet can include a case or frame to increase ruggedness. In one embodiment, the tablet computer can be augmented (physically and/or electrically) by attaching the tablet to a hardware module 142 (e.g., an externally connected module that includes the components indicated in boundary 140) that provides features not available in commercial off-the-shelf tablets, such as, e.g., a wireless access point, a WiFi hotspot, a printer, a barcode scanner wand, a photosensor, an ultrasound probe, etc. In this way, the tablet or any computer or computer-like device can be transformed into a hub 100 by plugging in the external module 142 that includes the modules/functions in accordance with the present principles.

The hub 100 can embed one or more computer processors that execute software, e.g., the communications module 122, which exchanges data and control with multiple medical devices and patient information systems. The software of the communications module 122 can provide a security module 134 for connecting with authorized devices and systems (e.g., secure pairing). The security module 134 permits the exchange of confidential medical data with authorized devices and systems (e.g., encryption). In one example, EMS workers, hospitals or other medical personnel or entities can be granted access to encryptions keys capable of identifying themselves as trusted partners. The security module 134 is configured to authorize access to the one or more monitoring devices by the hub 100 when the hub 100 enters a communication envelope of the one or more monitoring devices.

In one embodiment, the patient can provide a password or key to a safe repository or the like. In an emergency, the repository can be conferred with to obtain the password or key. Upon entering the scene, hospital, etc., a handshake protocol can be initiated to which the password can be presented by the hub 100 to local devices to initiate a communications link therewith.

In another embodiment, a local hub 100 can be linked to all the devices of the patient. The local hub 100 stores all relevant data until a more global hub 100′ enters into a vicinity of the local hub 100. The local hub 100 then uploads the relevant data to the global hub 100′. It should be understood that a plurality of different security systems and/or protocols can be put in place to secure the patient data in accordance with the present principles. Known security measures or modified security measures can be employed as needed. It should be noted that the hubs can be arranged in a hierarchical manner. For example, one local hub 100 can report to a family hub (for an entire family) (not shown) and the family hub can report to the hub 100′ upon entering the communications envelope.

In accordance with one embodiment, the display formatting module 128 can include a customizable or adaptive graphical user interface or “dashboard” for display on display 118. The hub 100 is configured for rapid scanning of critical real-time patient information such as physiological alarms (e.g., low blood pressure) or relevant history (e.g., recently hospitalized for myocardial infarction). This information can be rendered in appropriate fields, which can be configured in accordance with the available information. The display formatting module 128 can include panes for displaying detailed medical history records and diagnostic images (e.g., X-Rays, CT Scans, MM images, Ultrasound images and videos). Applications for viewing the images or data can be included in the apps/links 132 stored in memory 116.

Workstation 112 can be equipped with other tools and applications such as word processing software or other patient data entry editors 136 for entering patient care data (e.g., ePCR client software) or other information. Workstation 112 can include multiple input/output ports (130) that can provide capabilities for automatically importing and integrating data from connected medical devices and systems into a patient care record, and/or capabilities for forwarding the patient care record to the hospital and/or EMS agency incrementally in real-time or as a complete patient event record after completion of the event.

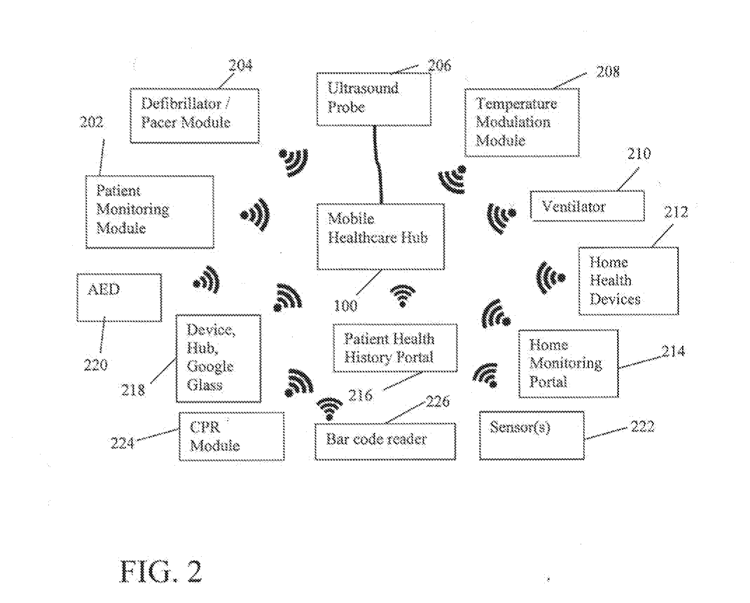

Referring to FIG. 2, the central monitoring hub or mobile healthcare hub 100 is illustratively shown with wireless and wired connections to a variety of medical devices and patient medical record systems in accordance with one exemplary embodiment. In one embodiment, the mobile healthcare hub 100 includes a rugged tablet computer with a touch-screen display, and wireless data communications capabilities such as Bluetooth® and/or WiFi for communications with local devices and systems and/or cellular for communications for remote devices and systems. Additional capabilities can include barcode scanning using a bar code reader 226 for reading patient identification and scanning medications and video and audio links for consulting with remote medical specialists (i.e., telemedicine). The hub 100 can include some or all of the integration capabilities described herein. Note that these capabilities, as presented, are illustrative and should not be construed as limiting the capabilities of the hub 100.

The hub 100 communicates with one or more monitoring devices (102, FIG. 1). These monitoring devices can include, e.g., a defibrillator/pacer module, a patient monitoring module, a patient health history portal, a home monitoring portal, home health devices or sensors, a ventilator, a cardiopulmonary resuscitation (CPR) module, a temperature modulation module, etc. These devices are referred to as modules since they can be connected with other consoles or devices. It should be noted that these devices can also be stand-alone units with communications capabilities.

A patient monitoring module 202 provides acquired patient vital measurements. The hub 100 receives this data for display, logging and transmission of patient vital measurements including, e.g., ECG (electrocardiogram), SPO2 (pulse oxyimetry), NBP (non-invasive blood pressure), EtCO2 (end-tidal carbon dioxide), CO (carbon monoxide), temperature, IBP (invasive blood pressure), etc. The hub 100 can also provide controls of the measurements such as setting alarm limits, calling for updated measurements, adjusting measurement parameters, etc. The hub 100 and/or devices will preferably be set up with the authority to permit the hub 100 to control the devices. The hub 100 can import patient data stored by defibrillator 220, such as an advanced life support (ALS) defibrillator, an automated external defibrillator (AED) or a wearable defibrillator prior to connection.

A defibrillator/pacer module 204 delivers electrical therapies including defibrillation shock, synchronized cardioversion and transcutaneous pacing. The hub 100 receives status (e.g., energy setting and mode of operation), events (e.g., shock delivered) and alarms (e.g., pad impedance too high for shock) for display, logging and transmission.

Defibrillator 220 analyses ECG to determine if shock is advised and delivers defibrillation shock. The hub 100 receives status (e.g., energy setting and mode of operation), events (e.g., shock delivered) and alarms (e.g., pads impedance too high for shock) for display, logging and transmission. The hub 100 can import patient data stored by the defibrillator 220 prior to connection.

An ultrasound probe 206, which acquires and stores images and videos can be connected to and controlled by the hub 100. The hub 100 receives ultrasound images and videos for display, logging and transmission.

A temperature modulation module 208 cools or warms the patient via non-invasive (e.g., surface) or invasive (e.g., endovascular) methods. The hub 100 receives status (e.g., temperature setting, measured temperature), and alarms (e.g., coolant obstruction) for display, logging and transmission. A CPR (cardiopulmonary resuscitation) module 224 is configured to automatically deliver chest compressions or to monitor a caregiver's compressions and provide coaching (e.g., compress faster, compress deeper). The hub 100 receives status (e.g., compression rate and depth), and alarms (e.g., no compression time) for display, logging and transmission. The hub 100 can also correlate vital measurements such as CO2 readings to automatically adapt compression rate or depth for more effective CPR.

A ventilator module 210 mechanically moves breathable air into and out of the lungs (invasive via intubation or non-invasive via mask). The hub 100 receives status (e.g., ventilation rate and pressure), and alarms (e.g., obstructed air flow) for display, logging and transmission. The hub 100 can also correlate vital measurements such as CO2 readings to automatically adapt ventilation rate or pressure for more effective ventilation.

Home health devices 212 can include small, inexpensive patient-worn devices, such as blood glucose meters, ECG or heart rate monitors, respiration rate monitors, SpO2 monitors, etc. The hub 100 receives measurements, status and alarms for display, logging and transmission. Home health devices 212 can have very limited capabilities for storing measurement data.

A home monitoring portal 214 can include systems like Philips® TeleStation™ and transmit measurement data from the home health device 212 to a data storage system in the portal 214 or accessed through portal 214. The hub 100 imports data from this storage system for display.

A patient health history portal 216 includes a patient data record storage system, such as a Health Information Exchange (HIE) that provides access to patient data from emergency treatments, hospitalizations, and physician visits. The hub 100 imports data from this storage system for display.

Other devices can include caregiver devices 218, such as Google Glasses™, laptops, tablets, smart phones, etc. These devices can be equipped with apps that report directly to hubs 100, and can themselves function as a localized hub (100) with appropriate permissions granted to hub 100, when within the vicinity of the device 218. Other devices can include sensors 222 with reporting capabilities.

The mobile healthcare hub 100 integrates information from a variety of medical devices, sensors, and patient information systems and displays or otherwise makes the information instantly available to a caregiver. In exemplary embodiments of the present invention, once a patient is logged into the hub 100, the patient's data can be collected from multiple sources in multiple environments. For example, a patient's information can be relayed to a dispatcher and logged into the hub 100. The EMS ambulance may leave a hospital and be permitted access to some or all of the patient's data from the hospital (e.g., patient history). Upon arrival at the scene, the hub 100 can collect updates or additional data, from the patient's own devices (e.g., new updated heart rate, temperature, etc.).

Permissions for patient data may have been granted a priori or the patient may have a local hub at their location that can be monitoring multiple devices and when the EMS worker's hub is in the vicinity data from the patient local hub can upload its data to the EMS hub 100. The permissions for this can also be set a priori.

The mobile healthcare hub 100 can facilitate advanced real-time communications between multiple medical devices and workstations (e.g., between EMS ALS defib. in the field and hospital, within a hospital). Advanced communications can include, e.g., intelligent processing for prioritization and targeted/selective communication and display based on patient, circumstances, practitioner, number of devices, device activity and/or role, location, environmental conditions, available and used resources, communication bandwidth and timing needs. Hub 100 can be automatically set to facilitate advanced communications based on preconfigured or predetermined settings and/or industry protocols. User input can be entered through a user interface and used for manual adjustments and overrides to one or more settings.

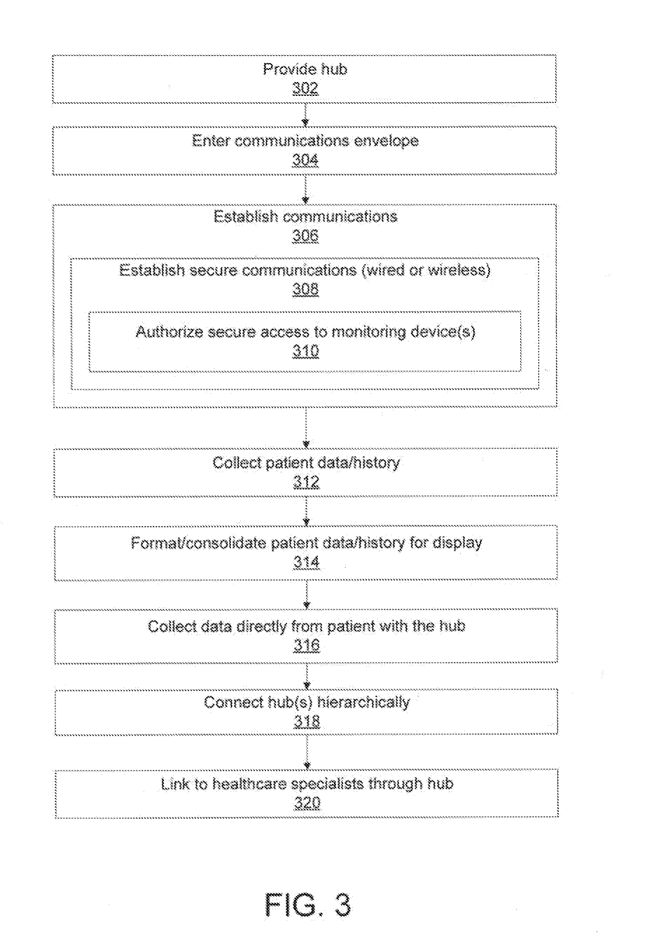

Referring to FIG. 3, a method for remotely accessing patient data is illustratively described and shown in accordance with the present principles. In block 302, a mobile healthcare hub is provided. The hub includes at least one processor, memory coupled to the at least one processor, a display coupled to the processor and a communications module. The communications module can be stored in memory or include an external attachment (e.g., in a USB port). The communications module includes a mobile communication device configured to communicate with one or more monitoring devices. The one or more monitoring devices are configured to store measurement data and/or historic data for a particular patient. An information monitoring module is included and configured to receive, consolidate and process the measurement data and/or historic data for the particular patient from the monitoring devices based upon relevance and context. A display formatting module is configured to receive the measurement data and/or historic data for the particular patient and format the measurement data and/or historic data.

In block 304, a communications envelope of the one or more monitoring devices is entered by the hub (or vice-versa). In block 306, communications are established between the one or more monitoring devices and the hub. The establishment of communications can include establishing secured wired or wireless communication with one or more of the monitoring devices in block 308. In block 310, the establishment of secured wired or wireless communication can include authorizing secure access to the one or more monitoring devices by the hub when the hub enters the communications envelope of the one or more monitoring devices. Wired communications can provide authorization by simply plugging into a device, although additional permissions may also be needed as well.

In block 312, patient data including the measurement data and/or historic data are collected for the particular patient from the one or more monitoring devices. In block 314, the patient data is formatted and consolidated for display on a display of the hub.

In block 316, data can be collected in real-time directly from the patient using the hub, e.g., collecting data from the patient using the hub can include gathering image data from a patient using a probe connected to the hub, scanning prescription bar codes using a bar code scanner, etc.

In block 318, a hub can be included as a monitoring device. Hubs can be hierarchically connected to gather patient data locally from a plurality of monitoring devices for uploading to a hub higher in the hierarchy. In block 320, the hub can be linked (video or audio) with healthcare specialists to be connected through the hub.

In interpreting the appended claims, it should be understood that:
a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or software implemented structure or function; and
e) no specific sequence of acts is intended to be required unless specifically indicated.

Having described preferred embodiments for a mobile healthcare hub (which are intended to be illustrative and not limiting), it is noted that modifications and variations can be made by persons skilled in the art in light of the above teachings. It is therefore to be understood that changes can be made in the particular embodiments of the disclosure disclosed which are within the scope of the embodiments disclosed herein as outlined by the appended claims. Having thus described the details and particularity required by the patent laws, what is claimed and desired protected by Letters Patent is set forth in the appended claims.

1. A mobile healthcare hub, comprising:
at least one processor;
memory coupled to the at least one processor;
a display coupled to the at least one processor; and
a communications module including a mobile communication device configured to communicate with one or more monitoring devices, the one or more monitoring devices being configured to store at least one of measurement data or historic data for a particular patient, the mobile communications device being connected to the one or more monitoring devices upon entering a communication envelope;
an information monitoring module configured to receive, consolidate and process the at least one of measurement data or historic data for the particular patient from the one or more monitoring devices based upon relevance and context; and
a display formatting module configured to receive the at least one of measurement data or historic data for the particular patient and format the at least one of measurement data or historic data for display on the display.

2. The hub as recited in claim 1, wherein the one or more monitoring devices include at least one of: (i) a defibrillator or pacer module, (ii) a patient monitoring module, (iii) a patient health history portal, (iv) a home monitoring portal, (v) home health devices or sensors, (vi) a ventilator, (vii) a cardiopulmonary resuscitation module, or (viii) a temperature modulation module.

3. The hub as recited in claim 1, wherein the mobile communication device includes an electronic interface configured for at least one of wired or wireless communication with one or more of the monitoring devices.

4. The hub as recited in claim 1, wherein the hub includes a port for connecting to an ultrasound probe for acquiring patient image data.

5. The hub as recited in claim 1, wherein the hub includes a bar code scanner for scanning one or more bar codes.

6. The hub as recited in claim 1, wherein the one or more monitoring devices include another mobile healthcare hub.

7. The hub as recited in claim 1, further comprising a security module configured to authorize access to the one or more monitoring devices by the hub when the hub enters a communications envelope of the one or more monitoring devices.

8. The hub as recited in claim 1, wherein the memory stores links for connecting with healthcare specialists through the hub.

9. A mobile healthcare hub, comprising:
a portable computer device having an external hardware module, the external hardware module, including:
a mobile communication device configured to communicate with one or more monitoring devices, the one or more monitoring devices being configured to store at least one of measurement data or historic data for a particular patient, the mobile communications device being communicatively connected to the one or more monitoring devices upon communicatively connecting a communication envelope; and
an information monitoring module configured to receive, consolidate and process the at least one of measurement data or historic data for the particular patient from the one or more monitoring devices based upon at least one of relevance or context;
a display formatting module configured to receive the at least one of measurement data or historic data for the particular patient and format the at least one of measurement data or historic data for display on a display; and
a security module configured to authorize access to the one or more monitoring devices by the hub when the hub communicatively connects the communications envelope of the one or more monitoring devices.

10. The hub as recited in claim 9, wherein the one or more monitoring devices includes at least one of: (i) a defibrillator, (ii) a pacer module, (iii) a patient monitoring module, (iv) a patient health history portal, (v) a home monitoring portal, (vi) a home healthcare device or sensor, (vii) a ventilator, (viii) a cardiopulmonary resuscitation module, or (ix) a temperature modulation module.

11. The hub as recited in claim 9, wherein the mobile communication device includes an electronic interface configured for at least one of wired or wireless communication with one or more of the monitoring devices.

12. The hub as recited in claim 9, wherein the hub includes a port for connecting to an ultrasound probe for acquiring patient image data.

13. The hub as recited in claim 9, wherein the hub includes a bar code scanner for scanning one or more bar codes.

14. The hub as recited in claim 9, wherein the one or more monitoring devices include another mobile healthcare hub.

15. The hub as recited in claim 9, wherein the memory stores links for communicatively connecting with one or more healthcare specialists through the hub.

16. A method for remotely accessing patient data, comprising:
providing a mobile healthcare hub having at least one processor, memory coupled to the at least one processor, a display coupled to the at least one processor, and a communications module including a mobile communication device configured to communicate with one or more monitoring devices, the one or more monitoring devices being configured to store at least one of measurement data or historic data for a particular patient; an information monitoring module configured to receive, consolidate and process the at least one of measurement data or historic data for the particular patient from the monitoring devices based upon relevance and context and a display formatting module configured to receive the measurement data or historic data for the particular patient and format the at least on of measurement data or historic data;
entering a communications envelope of the one or more monitoring devices by the hub, wherein the entering is performed by communicatively connecting to the communications envelope;
establishing communications between the one or more monitoring devices and the hub;
collecting patient data including the at least one of measurement data or historic data for the particular patient from the one or more monitoring devices; and
formatting and consolidating the patient data for display on a display of the hub.

17. The method as recited in claim 16, wherein the one or more monitoring devices include one or more of: (i) a defibrillator or pacer module, (ii) a patient monitoring module, (iii) a patient health history portal, (iv) a home monitoring portal, (v) a home healthcare device or sensor, (vi) a ventilator, or (vii) a temperature modulation module.

18. The method as recited in claim 16, wherein establishing communications includes establishing at least one of a secured wired communication or a secured wireless communication with one or more of the monitoring devices.

19. The method as recited in claim 18, wherein establishing the secured wired or wireless communication includes authorizing access to the one or more monitoring devices by the hub when the hub enters the communications envelope of the one or more monitoring devices.

20. The method as recited in claim 16, further comprising collecting patient data using the hub, wherein collecting patient data using the hub includes at least one of gathering image data from a patient using a probe connected to the hub or scanning one or more prescription bar codes using a bar code scanner.
